(19) United States
(12) Patent Application Publication
(10) Pub. No.: US 2021/0001491 A1
(43) Pub. Date: Jan. 7, 2021

(54) Optimized Placement Of Product On Flat-Line Conveyor

(71) Applicant: Hermance Machine Company, Williamsport, PA (US)

(72) Inventors: Ian Strouse, Pittsburgh, PA (US); Donald DeMotte, Oregonia, OH (US); Jurell Spivey, Williamsport, PA (US); Bradley G. Golder, Hughesville, PA (US)

(73) Assignee: Hermance Machine Company, Williamsport, PA (US)

(21) Appl. No.: 16/914,941

(22) Filed: Jun. 29, 2020

Related U.S. Application Data
(60) Provisional application No. 62/869,756, filed on Jul. 2, 2019.

(51) Int. Cl. B25J 9/16; B25J 9/00; B23Q 7/04

(52) U.S. Cl. CPC B25J 9/1697; B25J 9/0093; B23Q 7/048; B25J 9/1669; B25J 9/0084; B25J 9/163

(57) ABSTRACT

A computer-controlled system of placing product on a conveyor belt entrance to an industrial tool is based upon the combination of a 3D vision system (used to capture image data defining the surface area of a “next” product(s) to be placed) and a processor that is configured to determine an optimum location for placing that “next” product(s) on the conveyor belt. The processor then instructs a robotic arm to pick up and place the product at the processor-defined optimum location. Depending on the specific task to be performed by the industrial tool, the detailed analysis used to determine the optimum location will differ.

### CROSS-REFERENCE TO RELATED APPLICATIONS

This application claims the benefit of U.S. Provisional Application No. 62/869,756, filed Jul. 2, 2019 and herein incorporated by reference.

### TECHNICAL FIELD

The present invention relates to an industrial system requiring the use of a flat-line conveyor and, more particularly, to a robot-controlled pick-and-place system for efficiently loading product onto the conveyor belt in a manner that optimizes usage of the specific industrial system.

### BACKGROUND OF THE INVENTION

There are a variety of different industrial processes that utilize a flat-line conveyor belt to move product through a machine that performs one or more operations on the product. For example, metallic components of an assembly that require painting (staining/coating) may be placed on a conveyor belt and moved through an enclosed spraying apparatus. Wood products that require sanding may be placed on a conveyor belt and passed underneath a wide belt sanding apparatus. Food items may be loaded on a conveyor belt and passed through an oven to bake as they move along the belt.

Regardless of the application, the process typically requires workers to manually place the product on the conveyor belt. Inevitably, this technique yields problems in terms of efficiency, uniformity, and quality of the results. For example, in the case of applying a layer of spray paint, if the parts are too far apart, a significant amount of the paint is inevitably wasted by spraying vacant locations on the belt. On the other hand, if the parts are placed too close together on the conveyor belt, some areas may be left unpainted. In the case of a wood sander, when working with pieces of wood of differing sizes, the conveyor belt is more than likely not loaded to optimize even wear of the sanding belts through the entire line. Human operators tend to favor one side of the line or another, under-utilizing valuable abrasives that go to waste. With many sanding machines in a typical line (e.g., used to sand top and bottom sides of components), the value of increasing sanding belt life by 10% could amount to significant annual savings.

### SUMMARY OF THE INVENTION

The limitations of the prior art are addressed by the present invention, which relates to an industrial system requiring the use of a flat-line conveyor and, more particularly, to a computer-controlled pick-and-place system for efficiently loading product onto the conveyor belt in a manner that optimizes usage of the specific industrial system.

In accordance with the principles of the present invention, an optimized product placement system utilizes a combination of a three-dimensional (3D) vision system and computer-controlled robotic arm to perform the placement of individual product on a conveyor belt. The 3D vision system is used to scan and capture image data of the size of a “next” product/object to be placed on the conveyor belt (this is taking place as the robotic arm itself is placing the current product on the conveyor belt). Using pre-loaded software in memory, a processor uses the information from the 3D vision system to determine an optimum position on the conveyor belt for this “next” product and instructs the robotic arm to pick up and place the product at the processor-defined optimum location. Depending on the specific task, the detailed analysis used to determine the optimum location will differ. For example, in the application of a spray coating, a predetermined gap needs to be maintained around the perimeter of each separate product to ensure that sidewalls are also properly coated. Alternatively, when passing sections of lumber through a sanding apparatus, it is preferred to maintain a compact placement of product while also having a relatively symmetric left/right distribution of pieces (in order to maintain relatively even wear on the sanding apparatus itself).

One or more embodiments of the present invention may utilize a robotic unit with “multiple” arms, allowing for several product units to be picked up during one process cycle, with the 3D vision system scanning each of these individual product units. The sets of image data are supplied to the processor, which then determines the most efficient placement of all of the units during a single “placement” procedure (involving sequential placement of the individual units being held by the multiple arms).

Another embodiment of the present invention may comprise a multi-stage arrangement, with each stage using the equipment and process outlined above to place product units on a defined section of the conveyor belt.

An exemplary embodiment of the present invention may take the form of a conveyor system for use with a fabrication process tool, where the conveyor system is used to control product placement along a conveyor belt of known dimensions. In various embodiments the conveyor system comprises a 3D vision system positioned to scan and record image data of incoming product units ready for placement on the conveyor belt, a robotic arm configured to pick up individual product units and place the picked product units at defined locations on the conveyor below, with a control system coupled to the 3D vision system and the robotic arm. The control system itself is implemented to include a processor configured with defined fabrication process tool parameters to determine placement rules for individual product units, the processor responsive to the image data for determining an optimum placement of a “next” product unit on the conveyor belt, and an arm controller responsive to the processor for transmitting the optimum placement information as arm control data to the robotic arm so as to control the defined location placement performed by the robotic arm.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a simplified diagram of an exemplary conveyor belt-driven industrial tool using the automated product placement system of the present invention;

FIG. 2 is a top view of the conveyor belt-driven industrial tool of FIG. 1, illustrating a typical prior art product placement process;

FIG. 3 is also a top view of the diagram of FIG. 1, but in this case illustrating the efficient product placement on the conveyor belt achieved by the vision-controlled system of the present invention;

FIG. 4 is a diagram illustrating an exemplary range of motion for a typical robotic arm;

FIG. 5 is a simplified diagram of an alternative embodiment of the present invention, in this case using a robotic component with multiple arms, allowing for multiple product units to be placed during one system cycle; and

FIG. 6 is a simplified diagram of yet another embodiment of the present invention, illustrating the capability of using multiple product placement stages along one conveyor belt.

### DETAILED DESCRIPTION

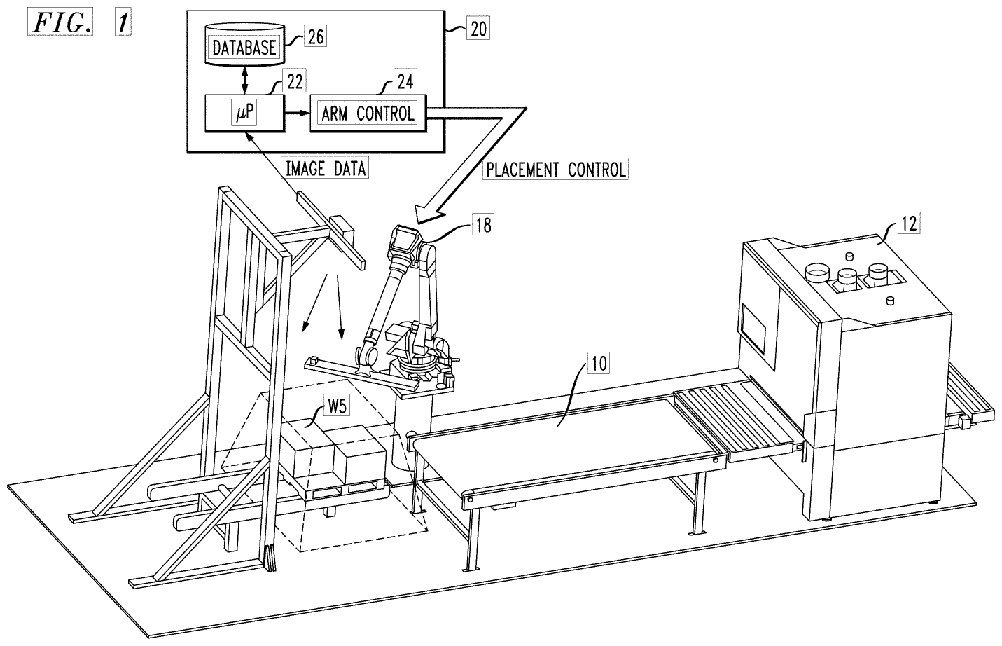

FIG. 1 is a simplified block diagram of an exemplary system utilizing the automated conveyor belt placement apparatus and method of the present invention. Shown in particular is a conventional conveyor belt 10 that is used to introduce product into an apparatus 12 used to perform a particular function. For example, as mentioned above, apparatus 12 may comprise a sanding tool, with conveyor belt 10 used to introduce various, random pieces of wood to apparatus 12. It is presumed for the purposes of the present invention that the pieces of wood are flat and are of varying surface area sizes.

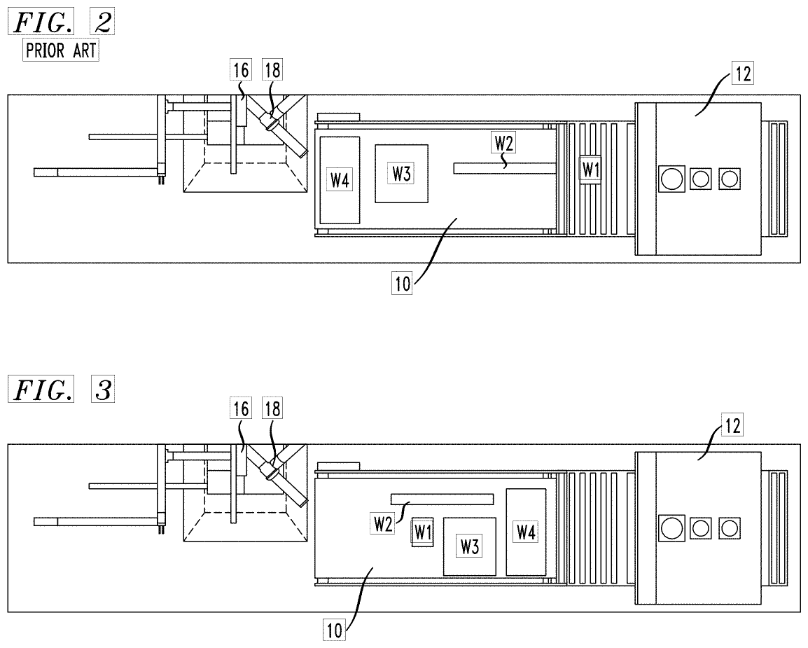

FIG. 2 is a top view of conveyor belt 10 and apparatus 12, showing a typical prior art method of placing product on belt 10. Here, each successive piece of wood to be sanded (denoted as W1, W2, W3 and W4 for the sake of explanation) is placed in a central region of conveyor belt 10 and passed through sanding apparatus 12. Even if mechanized apparatus is used to “pick and place” the pieces of wood onto conveyor belt 10, a conventional set of instructions for the mechanized apparatus would have each piece placed in a center region of belt 10 as shown, with rather large spacing between adjacent pieces. As mentioned above, this placement will result in uneven wear of the sanding apparatus itself, since the “edge” regions of the sander will not be used as much as the center region. If the configuration of FIG. 2 were used in combination with a spraying apparatus, it is apparent that a significant portion of conveyor belt 10 will itself be covered during the spraying process.

In accordance with the principles of the present invention, therefore, the combination of a 3D vision system to capture image data defining the surface area of a “next” product(s) to be placed and a processor that is configured to determine an optimum location for placing that “next” product(s) on a conveyor belt via a robotic arm is able to improve the throughput and quality of the associated process. FIG. 3 illustrates an exemplary optimum product placement as created by the computer-controlled system of the present invention. In particular, FIG. 3 shows the “compact” placement of the same four pieces of wood as placed in linear succession in the prior art arrangement of FIG. 2. The associated software employs processes similar to the popular game “Tetris” that is based on forming compact arrangements of different geometries.

Referring back now to FIG. 1, the system of the present invention is shown as including a 3D vision system 16 that is used to scan a surface area of a “next” piece of wood to be placed on conveyor belt 10 (here identified as “W5”). Also shown in FIG. 1 is a robotic arm 18 that is used to pick up and place the pieces of wood (or other product) on conveyor belt 10. In accordance with the principles of the present invention, the captured image data from 3D vision system 16 is transmitted to an included computer-controlled product placement module 20, which maintains a record of all previous placements of product. Based on this product placement “history”, product placement module 20 knows the current available empty space on conveyor belt 10 and determines the optimum location of the next piece (W5) accordingly. An arm control unit 24 within product placement module 20 then supplies this location information to robotic arm 18 in the form of x-y placement data, based on also knowing the width dimension of the particular conveyor belt.

In an exemplary embodiment, product placement module 20 includes a processor 22 that is initially configured for the type of operation to be performed (e.g., sanding vs. spraying, or the like). As mentioned above, the spacing of product on the belt, as well as its position across the width of the belt, is a function of the type of process being performed. A separate database 26 (or other type of information retention component) may store parameters associated with each possible type of operation, as well as the possible widths of the conveyor belt and advancement speed of the belt for a given operation. Thus, upon start-up, when the “operation type” input is provided to processor 22, it is able to retrieve the pertinent initialization data from database 26 and configure the necessary “design rules” for product placement. Once processor 22 is initialized, the 3D image data from vision system 16 is sequentially transmitted to processor 22 as each “next” product is scanned. Processor 22 then uses this image data to determine optimum product placement in association with the design rules. The location placement output from processor 22 is delivered by arm control unit 24 to robotic arm 18.

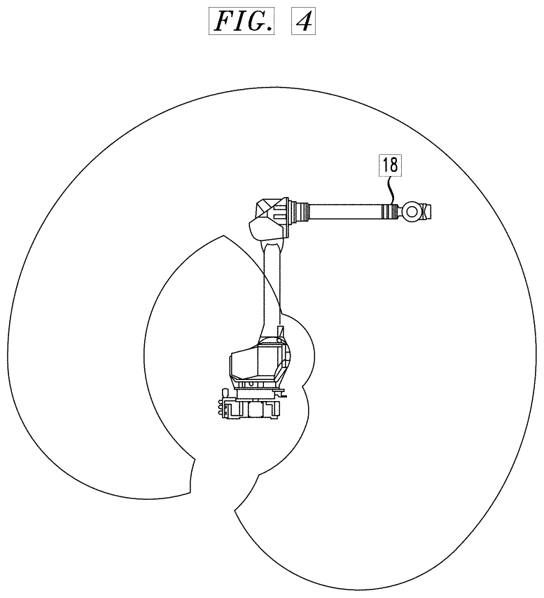

FIG. 4 is a top view of an exemplary range of motion for robotic arm 18, indicating its ability to place product at various locations on conveyor belt 10. For example, it may be necessary to place larger pieces toward a back area of belt 10 and then fill in smaller pieces across the width of belt 10 in a closer area. By virtue of knowing the full extent L of conveyor belt 10 available for product placement (and the speed of belt 10), the system of the present invention is able to continuously and consistently create an optimum arrangement of product to pass through apparatus 12.

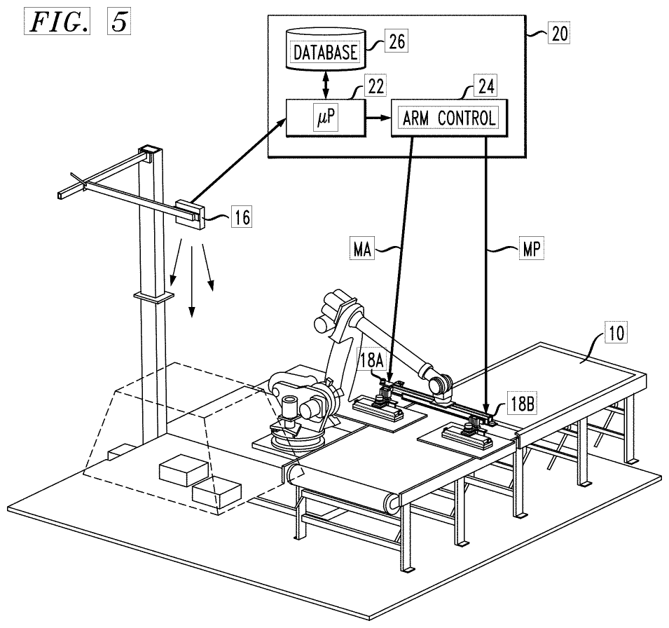

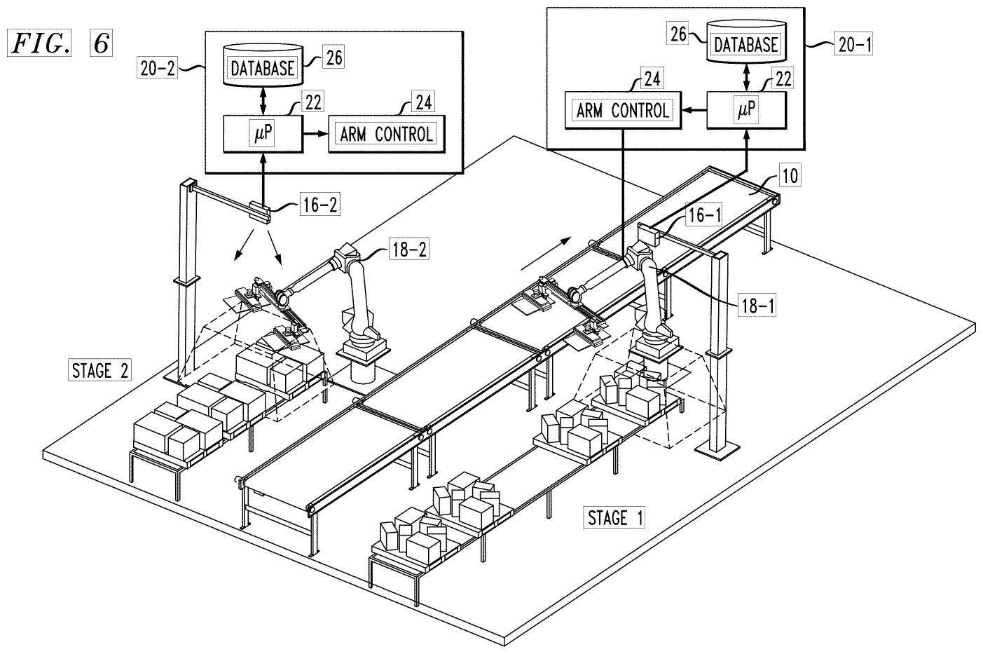

FIG. 5 illustrates an alternative embodiment of the computer-controlled product placement system of the present invention. In this particular embodiment, the robotic unit comprises a dual-arm pick-and-place configuration, shown as robotic arm 18A and robotic arm 18B. The use of a dual-arm placement system reduces the number of movements of the robotic unit between the incoming stock to be placed and conveyor belt 10, creating an efficient “double loading” system.

In accordance with this double loading embodiment of the present invention, 3D vision system 16 is to create image data for the “next two” items to be placed (identified here as W5 and W6), and sends this information to product placement control module 20. In this case, processor 22 is configured to analyze the dimensions of both pieces and determine their optimum locations on belt 10, taking both sets of data into consideration. The output from arm controller 24 thus sends a first control message MA to arm 18A and a second control message MB to arm 18B, where the messages will instruct the sequence of the two arms, as well as the placement locations of their products W5, W6. As before, while the placement is occurring, 3D vision system 16 is capturing the data associated with the “next two” products and the process continues in a similar manner.

Yet another embodiment of the present invention is shown in FIG. 6, which in this case illustrates a two-stage product placement system. As with the various embodiments described above, each stage includes a 3D vision system (denoted as systems 16-1 and 16-2 in FIG. 6) and a robot arm (denoted as 18-1 and 18-2 in FIG. 6). In one configuration, each stage may also utilize a separate control module (20-1 and 20-2). By virtue of using two separate stages, it is possible to load the belt in a more time efficient manner, with each stage given a defined belt “area” to cover. Once the two associated belt areas have been covered, the belt moves forward sufficiently to present empty belt sections at both stages.

In an alternative configuration of the multi-stage embodiment, the two stages may work together to efficiently load the same section of belt. For example, stage 2 may be used to position a first set of product, as controlled by placement decisions performed by processor 22-2 within computer-controlled product placement module 20-2. Stage 1 may have a set of pieces of several “known” sizes, and by knowing the vacant spaces remaining on the belt, is able to fill in the places with its additional pieces. In this configuration, a link needs to be established between control modules 20-1 and 20-2 so that stage 1 knows the placement history of stage 2.

It is to be noted that the various embodiments described above are exemplary only, and various other configurations and arrangements may be contemplated and are considered to fall within the scope of the present invention as defined by the claims appended hereto.

What is claimed is:

1. A conveyor system for use with a fabrication process tool, the conveyor system controlling product placement along a conveyor belt of known dimensions at the input to the fabrication process tool and comprising:
a 3D vision system positioned to scan and record image data of incoming product units ready for placement on the conveyor belt;
a robotic arm configured to pick up individual product units and place the picked product units at defined locations on the conveyor below; and
a control system coupled to the 3D vision system and the robotic arm, the control system including
a processor configured with defined fabrication process tool parameters to determine placement rules for individual product units, the processor responsive to the image data for determining an optimum placement of a “next” product unit on the conveyor belt; and
an arm controller responsive to the processor for transmitting the optimum placement information as arm control data to the robotic arm so as to control the defined location placement performed by the robotic arm.

2. The conveyor system as defined in claim 1 wherein the fabrication process tool comprises a sanding tool and the design rule parameters include maximizing surface area fill of the conveyor belt.

3. The conveyor system as defined in claim 2 wherein the design rule parameters further include a restriction on rotation of the product unit.

4. The conveyor system as defined in claim 1 wherein the fabrication process tool comprises a spraying tool and the design rule parameters include minimum gap spacing between units across the width of the belt and along the extend of product placement along the belt.

5. The conveyor system as defined in claim 4 wherein the design rule parameters further include a permission to rotate each product unit in order to optimize spray coverage.

6. The conveyor system as defined in claim 1 wherein the robotic arm comprises two or more pick-and-place members, the control module further configured to control the order of product unit placement performed by each member.

7. A conveyor system including multiple stages of optimized product placement along a conveyor belt, each stage comprising:
a 3D vision system positioned to scan and record image data of incoming product units ready for placement on the conveyor belt;
a robotic arm configured to pick up individual product units and place the picked product units at defined locations on the conveyor below; and
a control system coupled to the 3D vision system and the robotic arm, the control system including
a processor configured with defined fabrication process tool parameters to determine placement rules for individual product units, the processor responsive to the image data for determining an optimum placement of a “next” product unit on the conveyor belt; and
an arm controller responsive to the processor for transmitting the optimum placement information as arm control data to the robotic arm so as to control the defined location placement performed by the robotic arm.
